(19) United States
(12) Patent Application Publication
(10) Pub. No.: US 2014/0065051 A1
(43) Pub. Date: Mar. 6, 2014

(54) METHOD FOR MANUFACTURING SILICON CARBIDE POWDER

(71) Applicant: SHINANO ELECTRIC REFINING CO., LTD., Tokyo (JP)

(72) Inventors: Yoshihiro Kubota, Tokyo (JP); Masahiro Mochizuki, Tokyo (JP)

(21) Appl. No.: 13/923,774

(22) Filed: Jun. 21, 2013

(30) Foreign Application Priority Data
Aug. 31, 2012 (JP) 2012-191605

(51) Int. Cl. C01B 31/36

(52) U.S. Cl. CPC C01B 31/36
USPC 423/345

(57) ABSTRACT

A method for revitalizing worn and fatigued silicon carbide powder thermally reacted it continuously with a mixture of silicon oxide powder and/or carbon powder and a boron and carbon-containing additive in a non-oxidizing atmosphere at a temperature higher than 1850 degrees C. but lower than 2400 degrees C.

The present non-provisional application claims priority, as per Paris Convention, from Japanese Patent Application No. 2012-191605 filed on Aug. 31, 2012, the disclosure of which is hereby incorporated by reference herein in its entirety.

### FIELD OF THE INVENTION

This invention relates to a method for manufacturing a silicon carbide powder, and it intends to reclaim and recycle silicon carbide powder for reuse by processing the fine or ultra-fine powders of silicon carbide and silicon and their mixture powder to a larger size suitable for a use, thereby rendering such powders, which have been considered waste on account of the difficulty of their reuse, reusable.

### BACKGROUND TECHNOLOGY

In recent years, silicon carbide powder has been frequently used for cutting, grinding, and polishing single crystal or polycrystalline substrates made of silicon, quartz, SiC, GaAs, GaN, etc., as well as glass and ceramic articles, and also as a raw material to make SiC articles. The silicon carbide powder is normally manufactured through a batch reaction in accordance with Acheson method. This Acheson method makes use of an open atmospheric U-shaped furnace, along the centerline of which a graphite electrode is inserted and a mixture of silica sand and carbon is piled over the electrode like a flour paste cake in the form of a tube having a thickness of several millimeters to several centimeters, and a large amount of electricity is streamed through the graphite electrode to thereby heat and turn the mixture to SiC.

As the reaction in this Acheson method (SiO2+3C→SiC+2CO) is an endothermic reaction, the reaction proceeds well in the vicinities of the heat-creating high temperature graphite electrode and produces mainly a high temperature stable crystal α-SiC, whereas in parts remote from the electrode the reaction either is incomplete or largely produces a mixture of β-sic and α-SiC, which former is a low temperature stable crystal and is relatively limited in application breadth.

After the reaction, the product in the form of a consolidated hard clod is brought out of the furnace and crushed roughly and only the desirous α-SiC pieces are collected and are more finely crushed, whereas the remnant pieces consisting of unreacted mixture of silica sand and carbon and mixture of β-sic and α-SiC are reclaimed as defective products and used again by being added to the reaction raw material. The finely crushed powder mentioned above are adjusted to have a grain size and a grain size distribution optimum to respective applications by means of wet classification, which utilizes water or the like, or dry classification, which utilizes air, nitrogen gas or the like. The thus obtained SiC fine powder is currently used in huge amounts as abrasive grain and grinding material for cutting, grinding, and polishing operations and as a raw material to make SiC articles.

Depending on different use purposes and applications a SiC fine powder is required to have different optimum mean grain size and grain size distribution, so that it is necessary to accommodate a classification step in the manufacture line wherein grains having desired grain size is separated from grains having undesired grain sizes, but in this classification step large amounts of aqueous solution of SiC ultra-fine powder and fine powder which are scarcely in demand are left over and how to dispose them is a current problem.

Also, there occurs a lot of waste fluid containing Si saw dust particles that are produced as an ingot or an article of single crystal or polycrystalline silicon is cut or ground, and how to dispose it is a big problem too.

Furthermore, for use with a wire saw to cut a silicon ingot or the like, a slurry is prepared by adding to a solvent such as water and oil a SiC fine powder as the grinding abrasive and ethylene glycol together with surfactant, rust-preventive agent and various other additives. When the slurry has been used for cutting a large number of single crystal or polycrystalline silicon ingots, the SiC fine powder which was at first of the optimum quality undergoes permanent set-in fatigue due to wear and chipping and consequently its grain size is reduced and/or its grain size distribution is broadened whereby the cutting capacity is reduced, and the slurry viscosity is increased due to the accumulation of the silicon saw dust particles with a consequence that the recycling use of the slurry becomes difficult and the slurry is replaced by a freshly prepared slurry. The fatigued useless slurry contains not only the solvent water or oil but also the worn and minimized SiC grains and Si saw dust particles and various additives agents so that it cannot be simply drained without incurring a pollution hazard and thus the disposal of the slurry is another big problem.

As is seen from IP Publications 1 and 2, there have been proposed methods for recovering and effectively reusing the fine powder mixture of SiC and Si recovered from the wire saw slurry waste fluid. These methods seek to recover for reuse the silicon saw dust particles in the form of SiC (Si+C→SiC), and they comprise steps of adding carbon in a form of, for example, petroleum coke or carbon black, to the waste slurry in an amount sufficient to convert the Si fine particles to SiC, obtaining a clotted sludge by drying the slurry or separating it with a centrifuge or a filter, and heating the sludge.

However these methods are not without practical problems and the obtained SiC is too fine a powder to be highly useful. The silicon saw dust powder which is recovered together with SiC is converted to new SiC by being heated and reacted with carbon; however, the starting Si, being wire saw dust fine particles, is a ultra-fine powder having a grain size of only one micron or smaller, and has a particle size distribution curve of a low sharpness so that the resultant SiC becomes ultra-fine particles having a diameter of about 10 microns and a particle size distribution curve of low sharpness, and as such has not been considered a suitable raw material for wire saw slurry and the like, which is required to have a sharp particle size distribution, and thus improvement of the quality is longed for.

On the other hand, with regard to the aqueous solution and waste fluid separated from the slurry, there have been trials of recovering the SiC and Si fine particles from them by centrifuge or filter for reuse; however, since the SiC and Si particles are ultra-fine powders, it is very difficult to completely separate them from the liquid, and thus, the present situation is that they are disposed of as industrial waste or incinerated, or else they are dried by heating consuming a considerable amount of heat and the dried SiC and Si residue is used as a cheap price deoxidizing agent for smelting and refining furnaces or as a raw material supplement for Acheson furnaces or the like.

In view of the current situation as described above, the present inventors have already proposed a method for recovering and reusing the fine powders of silicon carbide and silicon as well as the mixture powder of these. IP Publication 3 describes a method for reclaiming and reusing the fine powders wherein a separation promoting agent containing a carbon powder and a silicon oxide powder is used to enlarge the silicon carbide fine grains and silicon fine grains (through grain growth).

### PRIOR PUBLICATIONS

### IP Publications

[IP Publication 1]

(Japanese) Patent Application Publication H11-116227 (1999)

[IP Publication 2]

(Japanese) Patent Application Publication 2002-255532

[IP Publication 3]

(Japanese) Patent Application Publication 2011-37675

### SUMMARY OF THE INVENTION

### Problems the Invention Seeks to Solve

The above-described recycling method proposed by the present inventors is a fairly practical method in that it can enlarge the fine or ultra-fine powders of silicon carbide and silicon from the order of several micrometers to the order of about 10 micrometers. However, in order to be adopted widely as the abrasive particles for wire saw cutting, grinding and polishing, the fine powders of the silicon carbide and silicon ought to be enlarged further, and thus the present inventors pushed forward with extensive studies and found that it is possible to increase the size to at a maximum of about 100 micrometers or so if a B—C containing additive is added, and thus came to possess the present invention.

### Means to Solve the Problems

Hence, the present invention is characteristic in that it includes a step wherein a composition comprising fine silicon carbide powder and/or fine silicon powder as the chief ingredient(s) is reacted continuously with a mixture of silicon oxide and/or carbon powder(s) and B—C containing additive in a non-oxidizing atmosphere at a temperature higher than 1850 degrees C. but lower than 2400 degrees C. Also, this step of heated reaction of the present invention is carried out by using a pusher or rotary type airtight reaction furnace, which is designed to convey the reactants through a certain distance at constant intervals.

Also, in the present invention, the above-mentioned composition comprising fine silicon carbide powder and/or fine silicon powder as the chief ingredient(s) is the waste sludge and/or crystal silicon saw dust particles which occur as a wire saw cutting is conducted in the course of manufacture of silicon wafers or solar cell substrates.

Further, in the present invention, the above-mentioned B—C containing additive is either B₄C or a composition which is capable of producing B₄C at a temperature equal to or lower than the reaction temperature and it is preferable that this composition consists of B₂O₃ and carbon.

### Effects of the Invention

According to the present invention, it is possible to convert the worn SiC and Si saw dust particles ground to several micrometers to SiC particles enlarged to a maximum of about 100 micrometers, so that the enlarged particles can be used, as they are or after being suitably pulverized, for various high priced valuable applications as the abrasive particles for wire saw cutting, grinding and polishing and the like.

### EXAMPLES FOR EMBODYING THE INVENTION

Now, we will describe the method of the present invention in detail.

The composition comprising silicon carbide powder and/or silicon powder as the chief ingredient(s) can be obtained from a solution or waste fluid containing at least fine silicon carbide particles and/or fine silicon oxide particles. These solution or water fluid can be, for example, (a) a solution containing unwanted SiC fine particles which are produced as a by-product during a wet classification stage such as water classification in a manufacture process of SiC fine particles, or a solution in which is dispersed unwanted SiC fine particles which are produced as a by-product during a dry classification stage such as sieve classification; (b) a waste fluid containing silicon saw dust particles which occur as an ingot or a shaped article of single crystal or polycrystalline silicon is cut or ground; or (c) a waste slurry fluid containing SiC fine particles and Si fine particles which occur as an ingot of single crystal or polycrystalline silicon is sliced by wire saw with the help of SiC abrasive to manufacture wafers and thin pieces.

Also, in order to extract solid elements such as silicon carbide powder or silicon powder from these solution and waste liquid, it is possible to adopt the “method for recovering solid fine particles” which was proposed by the present applicant inventors in an already filed patent application (Japanese Patent Application Publication 2011-208967) whereby solid elements are obtained by means of solid-liquid separation. According to this method, an organic coagulant, for example, is added to thereby agglomerate silicon carbide or silicon particles of relatively small sizes and the liquid containing the resultant conglomerates is centrifuged or filtered to recover the solid elements.

Incidentally, as the above-mentioned composition of the present invention is waste sludge and/or silicon crystal saw dust particles which occur as the wire saw cutting is conducted in the course of manufacture of silicon wafers and solar cell substrates, the conglomeration reaction becomes an exothermic reaction so that the energy consumed in order to maintain high temperature during the reaction is smaller compared to the endothermic reaction of Acheson method, and thus the present invention is economically preferable too.

Next, the thus separated and recovered solid elements are mixed with silicon oxide powder and/or carbon powder, and also with a B—C containing additive. The grain size of the silicon oxide mixed with the solid element scarcely affects the yield of the SiC produced, unlike the carbon powder, but if it is too large the reaction velocity is decreased without any again, so that its mean grain size is preferably 1 mm or smaller.

The carbon powder plays a roll of being one of the reactants to produce the SiC as well as being the reaction field, and hence it determines the reaction velocity and the yield of the SiC produced, and its preferable mean grain size is 1 mm or smaller and more preferably 0.1 micrometer-100 micrometers. If the mean grain size is too large the reaction velocity lowers and the yield of the SiC produced also lowers so that the economic gain is lost. Possible carbon species may include charcoal, coke, and activated carbon.

The above-mentioned mixture is continuously heated in a non-oxidizing atmosphere at a temperature higher than 1850 degrees C. but lower than 2400 degrees C. As the result of this heating, the fine powders of silicon carbide and/or silicon undergo reactions within the mixture with powders of silicon oxide and/or carbon and further with B—C containing additive(s) in a non-oxidizing atmosphere, and the fine particles of the silicon carbide and/or silicon powders are enlarged (grain growth). On this occasion, the determination of whether to add to the solid elements the silicon oxide powder alone or the carbon powder alone or, if both are added, at what ratio between them, is made suitably depending on the desired extent of the enlargement of the SiC grains and the ratio of the contents of the raw SiC to Si which participate in the reaction, among others.

The fine silicon carbide and/or silicon powder particles, for example minimized or worn SiC powder particles which remain in a waste fluid, are consumed, during the heated reaction, as a raw material to feed the enlargement of the newly produced SiC particle itself or as cores for the grain growth. Therefore, the amounts of the silicon oxide and/or carbon powders to be admixed vary depending on the composition of the solid elements obtained by solid-liquid separation.

The B—C containing additive of the present invention is selected from B₄C and compositions that produce B₄C at a temperature equal to or below the reaction temperature, and a combination of cheap B₂O₃ and carbon is economically preferable. As for the particle size of the B—C containing additive, it should be fine enough for the reason of easiness in mixing and, like carbon powder, 0.1-100 micrometers is optimum. As for the amount of addition, 0.5-15 wt % to the total solid elements is preferable for the reason of effectiveness and economy.

Incidentally, the effect of the B—C containing additive of the present invention is not merely to promote the densification of the sintered body of SiC at the time of sintering as is the common role of a sintering aid. According to a theory (“SiC type Ceramic New Materials” p. 214, published by UCHIDA ROKAKUHO PUBLISHING CO., LTD.), a sintering aid consisting of B—C containing additive turns, by virtue of its B(B₄C) or C, the SiO₂ layer covering the surface of SiC particle, which restricts sintering, to B₂O₃ and SiO, or CO and SiO, which are easy to volatilize and do volatilize, and thus allow densification to proceed; however, contrary to this theory, in the present invention, it was found a most economical (B₂O₃ plus C) was effective and thus a preferable B—C containing additive, and this fact cannot be explained by the theory or mechanism conventionally known about sintering aids. Therefore, the method of the present invention wherein an enlarged SiC particle is obtained by means of addition of B—C containing additive, especially (B₂O₃ plus C), is a new invention and idea that has not been possessed by any heretofore, and it brings about an excellent result.

As we have explained, in the present invention, the step of continuously heated reaction at a temperature higher than 1850 degrees C. but lower than 2400 degrees C. is essential at least to enlargement (grain growth) of SiC and/or obtainment of new SiC particle product, and furthermore, in order to obtain a high yield, it is preferable to adopt such a temperature gradient after producing a silicon carbide precursor and/or a β-silicon carbide that causes them to undergo crystal transition to become an α-silicon carbide.

The intermediates which are produced as the silicon oxide is deoxidized by carbon are SiO and Si as shown in the following equations (1) and (2):

SiO₂+C=SiO+CO (1)

SiO+C=Si+CO (2).

Also, the reaction by which silicon is carbonized to be silicon carbide is shown in the following equation (3):

Si+C=SiC (3)

In practicing the present invention, and in particular in selecting a combination of the intermediates SiO and Si, which are produced, for example, as the reactants to produce SiC, namely silicon oxide and carbon, are deoxidized, or a combination of the raw material Si such as saw dust particles retained in the recovered solution or waste fluid, B₂O₃, which is a preferred B—C containing additive as being of a cheap price and hence economical, and carbon, this B₂O₃ is easy to volatize at a high temperature so that in order to attain a high yield of SiC on the occasion of the heated reaction, it is preferable not to raise the temperature sharply at the early stage of the reaction so as to avoid a volatilization in the form of SiO, Si and B₂O₃, so as to promptly obtain the production of B₄C or its precursor from B₂O₃ and C at a temperature between 1100 and 1850 degrees C. or the production of a precursor of silicon carbide and/or β-silicon carbide through a reaction between silicon oxide and carbon, and also it is preferable to adopt, thereafter, a temperature gradient such that, as the temperature is raised to higher than 1850 degrees C. but lower than 2400 degrees C., the reactants undergo a crystal transition to produce β-silicon carbide.

The reason for this is that, whether it is the precursor for silicon carbide or β-silicon carbide, when they are turned to SiC compound or B₄C or a precursor of the foregoing, the vapor pressure becomes so low that even decomposition does not occur unless the temperature is 2400 degrees C. or higher, so that there occurs scarce loss of material, and if the final highest temperature is not higher than 1850 degrees C., it becomes difficult to attain complete conversion to α-silicon carbide.

Incidentally, the non-oxidizing atmosphere may be an atmosphere of a gas selected from nitrogen, argon, and the like.

Now, we will explain about the method for creating temperature gradient during the heated reaction. Examples of such method is to use a furnace which is equipped with a plurality of regions that can have different temperatures or to use a plurality of furnaces having different temperatures, and the reactants are moved from the lower temperature furnace (region) to higher temperature furnaces (regions). And from the viewpoints of mass productivity, effectiveness in obtaining optimum temperature gradients, low occurrence of dust, good thermal efficiency, and easiness in recovery of the by-product gas, the most preferable is a closed type (airtight) reaction furnace which can move substances through a constant distance at constant intervals, for example, a pusher-type reaction furnace capable of temperature controlling and a rotary-type reaction furnace.

The silicon carbide particles obtained through the method of the present invention have a mean particle size of several tens of micrometers to a maximum of about 100 micrometers, and in reuse they are pulverized by a pulverizer, if need be. If an enlarged silicon carbide particle of a maximum of about 100 micrometers is pulverized, the resulting sub-particles can easily have sharp edges, which make them suitable abrasive grains for wire saw cutting, and this is another benefit obtained by the present invention. Thus, these recreated silicon carbide powders can be reused as abrasive particles for wire saw cutting, grinding, polishing, etc.

### EXAMPLES

### Example 1

Now we will explain the present invention using concrete examples, but the invention is not to be construed limitedly by them. An α-SiC was manufactured by Acheson method and was pulverized to a mean particle size of 10 micrometers, and over-large particles and over-small particles of them were cut off by water classification. The over-large particles were returned to join newly made α-SiC for pulverization. A 1000 kg of aqueous solution containing the over-small particles of a mean particle size of 2 micrometers or smaller (solid ratio being 40%) and 48 kg of charcoal particles having a mean particle size of 80 micrometers and a specific surface area of 393 m²/g and also 70 kg of silica powder having a mean particle size of 120 micrometers were mixed uniformly, and filtrated with a Excel Filter JX-3030 (manufactured by Sanritsu-Kiki Co., Ltd.). The solid-liquid separation went good and the filtrate was soiled with scarce fine particles and was transparent. The thus recovered solid cake was mixed with B₄C, the latter accounting for 5 wt % of the mixture, which was then dried. The solid mixture was then put in a container and was heated to undergo chemical reactions as the container was transported in a pusher furnace of an atmosphere of argon gas stream, in such a way that the mixture stayed for 30 minutes in each zone of the furnace, namely a first zone controlled to 1400 degrees C., a second zone to 1600 degrees C., a third zone to 1800 degrees C. and a fourth zone to 2300 degrees C.

It was found that in the first, second and third zones almost no volatilization of Si and SiO took place and the yield of the β-silicon carbide was almost 100% of the theoretical value, and that in the fourth zone total crystal transition to α-SiC took place. Then in the atmosphere, an excessive part of the carbon was removed by heating at 750 degrees C. As the result, the over-small particles of α-SiC having a mean particle size of 2 micrometers or smaller could be enlarged to become α-SiC particles of a mean particles size of 20 micrometers (thus a grain growth took place). These enlarged SiC particles were pulverized by jet mill and were subjected to water classification, and then dried. Edged and angular α-SiC particles having a mean grain size of 10 micrometers were obtained at a yield of about 80%. When used as abrasive grain for wire saw cutting, the cutting efficiency showed a very good result.

### Comparative Example 1

Except that B₄C was not admixed to the recovered solid cake, all the procedures of Example 1 were observed in this Comparative Example 1, wherein the product thus manufactured was non-angular α-SiC particles having a mean grain size of 9.6 micrometers in contrast to the mean grain size of 20 micrometers in Example 1, and the yield was about 78%. These particles were too small to be pulverized by the jet mill. When these α-SiC particles were used for wire saw cutting in the same manner as in Example 1, the cutting efficiency was only about 48% as good as of that in Example 1 and thus the abrasive quality was poor.

### Example 2

A wire saw waste fluid (solid elements consisting of α-SiC in an amount of 30 mass %, Si in an amount of 4.1 mass % and Fe in an amount of 0.9 mass % and the solution elements being a mixture of ethylene glycol, surfactant and water) was prepared, which was a waste fluid from a wire saw cutting operation for silicon wafer manufacturing, of which the solid part accounted for 35 mass % and the solution part accounted for 65 mass %. To 1000 kg of this wire saw waste fluid was added 500 g of cationic high polymer coagulant, and after mixing, the solution was subjected to solid-liquid separation operation. The solid-liquid separation went smoothly and the resultant filtrate was a colorless, transparent clear liquid. The resultant separated solid cake was mixed with 56 g of coke pulverized to a mean grain size of 15 micrometers and having a specific surface area of 50 m²/g and also with a composition of B₂O₃ and C (wherein the weight ratio B₂O₃/C was 1.4) in a manner such that the admixtures accounted for 10 wt %. This resultant solid cake mixture was dried and placed in a container and the container was transported through a rotary furnace staying in zones for 20 minutes each, in which a starting first zone was maintained at 1850 degrees (wherein almost 100% β-sic was produced), a second zone was maintained at 1950 degrees C., and a terminal third zone was maintained at 2200 degrees C., whereby the cake mixture was forced to undergo reactions in an atmosphere of Ar gas stream.

The thus re-manufactured product was a 100% α-SiC powder having a mean grain size of 38 micrometers. This was further pulverized and classified and dried in the same manner as in Example 1. As the result, it was possible to regain α-SiC particles of a mean grain size of 8.5 micrometers having sharp edges and high abrasiveness almost comparable to the SiC abrasive before use, at a yield of about 90%. Incidentally, the SiC particles in the waste fluid before reclaiming had a mean grain size of 3 micrometers and were without sharp edges and extremely worn out.

1. A method for manufacturing silicon carbide powder characterized by comprising a step wherein a composition containing fine silicon carbide powder and/or fine silicon powder as the chief ingredient(s) is thermally reacted continuously with a mixture of silicon oxide powder and/or carbon powder and a boron and carbon-containing additive in a non-oxidizing atmosphere at a temperature higher than 1850 degrees C. but lower than 2400 degrees C.

2. The method for manufacturing silicon carbide powder as claimed in claim 1 which is further characterized by that said step of thermal reaction is conducted in a pusher-type or a rotary-type air-tightly closed reaction furnace wherein said reactants are moved through a predetermined distance at predetermined intervals.

3. The method for manufacturing silicon carbide powder as claimed in claim 1 which is further characterized by that said composition containing fine silicon carbide powder and/or fine silicon powder as the chief ingredient(s) is a waste sludge and/or crystal silicon saw dust particles which occur as a wire saw cutting is conducted in the course of manufacture of silicon wafers and solar cell substrates.

4. The method for manufacturing silicon carbide powder as claimed in claim 1 which is further characterized by that said boron and carbon-containing additive is B₄C.

5. The method for manufacturing silicon carbide powder as claimed in claim 1 which is further characterized by that said boron and carbon-containing additive is a composition which is capable of producing B₄C at a temperature equal to or lower than said reaction temperature.

6. The method for manufacturing silicon carbide powder as claimed in claim 5 which is further characterized by that said composition which is capable of producing B₄C at a temperature equal to or lower than said reaction temperature comprises B₂O₃ and carbon.

7. The method for manufacturing silicon carbide powder as claimed in claim 2 which is further characterized by that said composition containing fine silicon carbide powder and/or fine silicon powder as the chief ingredient(s) is a waste sludge and/or crystal silicon saw dust particles which occur as a wire saw cutting is conducted in the course of manufacture of silicon wafers and solar cell substrates.

8. The method for manufacturing silicon carbide powder as claimed in claim 2 which is further characterized by that said boron and carbon-containing additive is B₄C.

9. The method for manufacturing silicon carbide powder as claimed in claim 3 which is further characterized by that said boron and carbon-containing additive is B₄C.

10. The method for manufacturing silicon carbide powder as claimed in claim 2 which is further characterized by that said boron and carbon-containing additive is a composition which is capable of producing B₄C at a temperature equal to or lower than said reaction temperature.

11. The method for manufacturing silicon carbide powder as claimed in claim 3 which is further characterized by that said boron and carbon-containing additive is a composition which is capable of producing B₄C at a temperature equal to or lower than said reaction temperature.
